(19) United States
(12) Patent Application Publication
(10) Pub. No.: US 2008/0176965 A1
(43) Pub. Date: Jul. 24, 2008

(54) Enhancing proton conductivity of proton exchange membranes

(75) Inventors: Yue Qi, Troy, MI (US); Tao Xie, Troy, MI (US); Timothy J. Fuller, Pittsford, NY (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM Global Technology Operations, Inc., Detroit, MI (US)

(21) Appl. No.: 11/625,876

(22) Filed: Jan. 23, 2007

(51) Int. Cl. C08J 5/22; B29C 39/00

(52) U.S. Cl. 521/27; 264/435

(57) ABSTRACT

The proton conducting capability of a proton exchange membrane is improved where the polymeric membrane material has a continuous non-ionic phase which provides the molecular backbone of the membrane and ionic phase clusters which provide the basis for proton exchange when the membrane is infiltrated with water or the like. In the formation of the membrane, the polymeric material is placed in a state in which the polymer chain segments are mobile and the ionic phase portions are aligned by application of an alternating electric field applied transverse or normal to the surfaces of the membrane. The aligned ionic phase increases the conductivity of the membrane in the direction through its thickness.

### TECHNICAL FIELD

This invention pertains to proton-exchange polymeric membranes for fuel cells. More specifically this invention pertains to a method of increasing the conductivity of such membranes where the membrane is formed of a single polymer material, and the molecules of the polymer display a morphology having a nonionic continuous phase and an ionic dispersed phase where the ionic dispersed phase provides conductivity properties to the membrane in a water-containing environment.

### BACKGROUND OF THE INVENTION

Fuel cells are electrochemical devices that are being developed for motive and stationary electric power generation. Typically each fuel cell comprises a stack of many individual electrochemical cells of like construction, in series electrical connection, to provide the power requirements of the device.

One fuel cell design uses a solid polymer electrolyte (SPE) membrane, or proton exchange membrane (PEM), to provide ion transport between the anode and cathode in each electrochemical cell of a multi-cell fuel cell stack construction. The anode and cathode are formed on opposite sides of the polymer electrolyte membrane. Gaseous and liquid fuels capable of providing protons are used. Examples include hydrogen and methanol, with hydrogen being favored. Hydrogen is supplied to each electrochemical cell anode. Oxygen (as air) is the cell oxidant and is supplied to each cell's cathode. The electrodes are formed of porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote ionization of hydrogen at the anode and reduction of oxygen at the cathode. Protons flow from the anode through the ionically conductive polymer membrane to the cathode where they combine with oxygen to form water, which is discharged from the cell. Electrons formed and released at the anode are conducted through a terminal to an external load.

Currently, state of the art PEM fuel cells utilize a membrane made of one or more perfluorinated ionomers such as DuPont's Nafion®. The ionomer carries pendant ionizable groups (e.g. sulfonate groups) for ionic transport of protons through the membrane from the anode to the cathode. The thickness of the membrane may be, for example, about 20 to 50 micrometers and the membrane must be infiltrated with water for proton conduction through its thickness. Accordingly the hydrogen fuel feed stream is typically humidified (e.g., up to 100% relative humidity in hydrogen at a cell operating temperature of, e.g., 80° C.) to provide water for membrane conductivity. Water is also produced at the cathode in cell operation. This by-product water may also wet and penetrate the surface of the membrane and enhance its capability for transport of protons. But by-product water is drained from the cathode side of each cell during operation of the device so that the cell is not flooded nor gas flow impeded.

For automotive applications, it would be desirable to operate fuel cells under low humidification conditions to minimize the cost of feed stream humidification and other costs associated with water management. However, known proton exchange membranes typically possess insufficient conductivity under dry conditions of, for example, twenty percent relative humidity. It is desired to increase the conductivity of the membranes at low humidity levels in the cell.

### SUMMARY OF THE INVENTION

In accordance with this invention, the fuel cell membrane is made of a polymer composition that has a microstructure comprising a non-ionic phase portion of the polymer molecules, which is the continuous phase, and an ionic phase of the same molecules which is usually dispersed in the continuous phase, at least in the dry state of the polymeric membrane. The continuous non-ionic phase provides the mechanical strength of the polymer (and the membrane) and the ionic phase enables proton transfer or conduction.

Perfluorosulfonic acid membranes are an example of an ionomer material that is a candidate for proton exchange membrane applications in automotive polymer electrolyte fuel cells. A representative formula for a Nafion® type perfluorosulfonic acid ionomer is shown below. The value of m determines the equivalent weight of the ionomer with respect to the sulfonate group and the value of n determines the molecular weight of the ionomer.

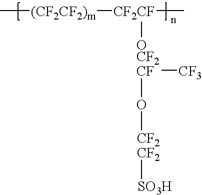

As seen in the formula, the perfluorosulfonic acid (PFSA) structure consists of a highly hydrophobic perfluoroethylene (PTFE) backbone with one or more fully perfluorinated ether side chains, with each side chain being terminated with the strongly acidic and hydrophilic —SO₃H group. This molecular structure leads to spontaneous phase segregation at the nano-structural level within the aggregated polymer molecules. For fully hydrated PFSA, the sulfonic groups and water develop an interconnected proton connecting network while the fluorocarbon backbone forms a semi-crystalline hydrophobic phase. The sulfonate group-terminated side chains are visualized as assuming the shapes of clusters attached to polymeric molecular chains.

The proton conductivity of fuel cell membranes relies heavily on morphological changes in a membrane under different levels of humidity. A membrane must be exposed to a certain minimum level of humidification in order for water molecules to percolate through the membrane and interconnect the ionic phase clusters with water to provide channels for proton conduction. Such a humidification level is called the “percolation limit” for the membrane It is the humidification level at which the ionic phase clusters become interconnected with water channels, and the membrane possesses suitable conductivity. Typical polymer electrolyte membranes have the ionic phase randomly dispersed in the nonionic phase. A significant amount of water is thus needed to reach percolation, which means a high water content threshold has to be reached to achieve useful proton conductivity. This is contrary to the desire to operate fuel cells under low humidification conditions for automotive application.

In accordance with this invention, an applied electrical field is used to suitably induce the preferential alignment of the ionic phase within the two-phase polymeric material as the electrolyte membrane is formed. The electric field is applied when the ionomer is in solution, or heated to a molten state, so that the polymer molecules are sufficiently mobile for the ionic groups to be aligned. For example, a solution of the two-phase ionomer or polymer is cast on a suitable processing surface for defining an electrolyte membrane of suitable shape and thickness. Electrodes are placed close to opposing major sides of the cast solution and an alternating electrical field of suitable potential is applied to the dissolved polymer molecules as the solvent is evaporated. The more mobile ionic groups (typically with higher dielectric constants than the non-ionic molecular backbones of the polymer molecules) are aligned normal to the cast solution. As the solvent evaporated the residual polymer membrane retains a morphology with electric field-aligned ionic groups.

Under the ideal condition, the expected morphology is one of the ionic phase constituting cylinders dispersed in the nonionic continuous phase and the ionic phase cylinders or clusters are aligned in the through-the-plane direction. Such an ordering would mean that, even in the absence of water, the ionic phase is continuous in the direction normal to the membrane surface. Under this circumstance, a smaller quantity of water is needed to hydrate the ionic phase to form a continuous proton conducting path. In a less ideal but more realistic situation, the ionic phase is stretched and preferably aligned along the membrane thickness direction. As a result, the membrane possessing the proposed morphology has high proton conductivity (in the direction normal to the membrane surface) at low relative humidity.

The purpose of the method of this invention is to improve the proton conductivity normal to the membrane surface. Prior to this invention, ex-situ proton conductivity measurement has been used to screen candidate fuel cell membranes. Typically, it measures proton conductivity parallel to the membrane surface, while in reality, protons travel perpendicularly to it. Such a measurement may be suitable to evaluate membranes of isotropic morphology but should not be used for membranes of anisotropic morphology as obtained in the practice of this invention.

The practice of the invention was described with reference to a membrane made substantially of perfluorosulfonic acid molecules. In addition to certain fluorinated polymers, the invention may also be practiced using a hydrocarbon ionomer (e.g., a non-fluorinated ionomer) to form the polymer electrolyte membrane. For example, a suitable membrane material may be selected from a hydrocarbon ionomer such as sulfonated polysulfone, sulfonated poly(ether ether ketone), sulfonated polyimide, sulfonated poly(phenylene oxide), sulfonated polycarbonate, or the like.

Other objects and advantages of the invention will be apparent from a disclosure of the practice of some preferred embodiments of methods of aligning ionic phases in the PEM normal to the surface of the membrane.

### BRIEF DESCRIPTION OF THE DRAWINGS

FIG. 1 is a graph of polarization curves of Nafion® samples at 80° C. and 70% relative humidity. The voltage readings (y-axis) were obtained from the higher current flow rate (current density, A/cm²) to low current flow rate with fifteen minutes delay between each acquired voltage data point. In each test the last five voltage readings were averaged and plotted in the graph to construct the polarization curve. The short-dashed line (filled circle) voltage readings curve was obtained from the Nafion® ionomer control sample membrane prepared without an applied electric field. The solid line curve and the long-dashed line curve are the polarization curves for the Nafion Sample #1 and Nafion Sample #2 membranes prepared under applied electric fields as described below in the specification.

FIG. 2 is a graph of polarization curves of Nafion® samples at 80° C. and 100% relative humidity. The voltage data was obtained as described with respect to the samples in FIG. 1. Again, the short-dashed line (filled circle) voltage readings curve was obtained from the Nafion® ionomer control sample membrane prepared without an applied electric field. The solid line curve and the long-dashed line curve are the polarization curves for the Nafion Sample #1 and Nafion Sample #2 membranes prepared under applied electric fields as described below in the specification.

### DESCRIPTION OF PREFERRED EMBODIMENTS

The method of this invention is practiced when the polymer chains of polymer electrolyte membrane material are in a condition or environment in which they possess suitably high mobility. When the polymer molecules are in such a state it is possible to align the ionic phase clusters of the molecules to improve proton transfer through the membrane. For example, a driving force for phase alignment lies in the difference in dielectric constants of the non-ionic and ionic parts of the same polymer molecules. In the case of Nafion®, for instance, the effect of electric field on phase separation is expected to be huge due to the large difference in dielectric constants between sulfonic acid and PTFE (the dielectric constants being 84 and 2 respectively).

In general, at least two options are available. For melt processable membranes, the desirable morphology can be achieved via annealing the polymer above its melting (or softening) point in the presence of a suitable alternating current electrical field. For soluble ionomers, the alternating electrical field can be applied at the membrane-casting step. Upon solidification (removal of heat or evaporation of solvents), the desirable morphology of aligned ionic clusters will form and not undergo change afterwards due to the limited mobility of polymer chains.

The inventors herein have used meso-scale mathematical modeling to obtain or predict morphologies of hydrated perfluorosulfonic acid (Nafion®) having an equivalent weight of 1100 (with respect to the incidence of —SO₃H groups). A course-grained mesoscale model was developed by dividing the polymer system into three components: backbone, side chain, and water. The model shows that, at an equilibrium condition of 20% water content, the water clusters form around five nanometer diameter spheres, with only a few spheres connecting. In other words with un-aligned ionic groups the ionomer provides low proton conductivity at 20% relative humidity in the membrane. However, for the same composition, alignment of the ionic phase (such as with an applied electric field) can form conducting channels along the applied field direction. The following described experimental work confirms this model. An ordered morphology in the ionomer membrane can be achieved using external forces and provide higher proton conductivity at lower water content.

### Sample Preparation

A solution of Nafion® ionomer prepared using (by weight) 20% ionomer, 35% water and 45% 1-propanol (DuPont DE2020, EW=1,000) was first cast onto a glass surface, which was then put between two copper plates separated by a TEFLON spacer (thickness of 0.3 cm). The typical membrane drying conditions were a first drying stage of three hours at 70° C. in quiescent air followed by a second higher temperature stage of two hours at 120° C., also in still air. This procedure yielded cast membranes of 50 mm long, 50 mm wide and 0.04 mm (forty micrometers) thick.

A control sample of the perfluorosulfonic acid ionomer, labeled “E-field control sample” was made without applying any electric field under the stated drying conditions. Thus the E-field Control Sample was prepared in a conventional casting method yielding an isotropic membrane in which there was no particular alignment of the ionic phase clusters.

“Sample #1” was made under an alternating electric field (1200V, 10 kHz) and under identical drying conditions as the control sample and the e-field was maintained during the membrane cooling at the end of drying cycle. “Sample #2” was made under conditions identical to sample #1 except that the e-field was imposed onto the copper plates for 24 hour at room temperature prior to the drying cycle.

### In-situ Through-Plane Proton Conductivity and Performance Measurements:

Through-plane conductivity was measured with impedance spectroscopy using a Zahner IM6e potentiostat over the frequency range from 1 kHz down to 1 Hz, and a current range between 0 and 1 amp, while the membrane was situated in actual fuel cell hardware and nested between platinum-carbon electrodes, and then sandwiched between carbon paper (graphitized carbon fiber) diffusion media, graphite flow-channels, and heated metal end-plates. The apparatus was equipped with an external humidifier.

An impedance spectrum consisting of the real vs. imaginary portion of alternating current resistance was determined for the fuel cell assembly with all the hardware components except the membrane. Imaginary impedance (Z_{imaginary}, in mΩ) was plotted against real impedance (Zᵣₑₐₗ, in mΩ) to generate a Nyquist plot, where at low phase angle and high frequency (at between 1 to 100 kHz), Zᵣₑₐₗ intersects the zero axis of Z_{imaginary}. At this point, HFR_{cell} (high frequency resistance) was obtained by multiplying the value of Zᵣₑₐₗ and the active area (5 cm²). HFR_{cell} is equal to R_{cell}, which is the internal resistance of the fuel cell hardware.

The same process was repeated with the same cell having the membrane situated in-place. The obtained HFRₜₒₜₐₗ is equal to R_{cell}+R_{membrane}+Rₑ, where R_{membrane} and Rₑ are the resistance of the membrane and electronic resistance of the electrode, respectively. Rₑ was the electronic resistance measured by passing a direct current through a cell built without a membrane electrode assembly (MEA).

The conductivity of a membrane (σ_{membrane})=thickness of membrane in cm (δ_{membrane}) divided by the resistance of the membrane, R_{membrane}. Thus, membrane proton conductivity in Siemens per centimeter,

σ_{membrane}=_{membrane}/R_{membrane}=δ_{membrane}/[HFRₜₒₜₐₗ−HFR_{cell}−Rₑ]

### Results

As shown in Table 1, samples made in the presence of the E-field (Sample #1 and Sample #2) show on average greater conductivity than the E-field control sample.

TABLE 1
Proton conductivities of Nafion samples

| | Conductivity (S/cm) at different relative humidity | | | | |
|---|---|---|---|---|---|
| Sample | 30% | 50% | 70% | 90% | 100% |
| E-field | 0.017 ± 0.006 | 0.040 ± 0.013 | 0.066 ± 0.022 | 0.130 ± 0.043 | 0.180 ± 0.060 |
| control | | | | | |
| Sample #1 | 0.021 ± 0.007 | 0.045 ± 0.015 | 0.083 ± 0.028 | 0.158 ± 0.053 | 0.225 ± 0.073 |
| Sample #2 | 0.027 ± 0.009 | 0.058 ± 0.019 | 0.118 ± 0.039 | 0.186 ± 0.062 | 0.295 ± 0.098 |

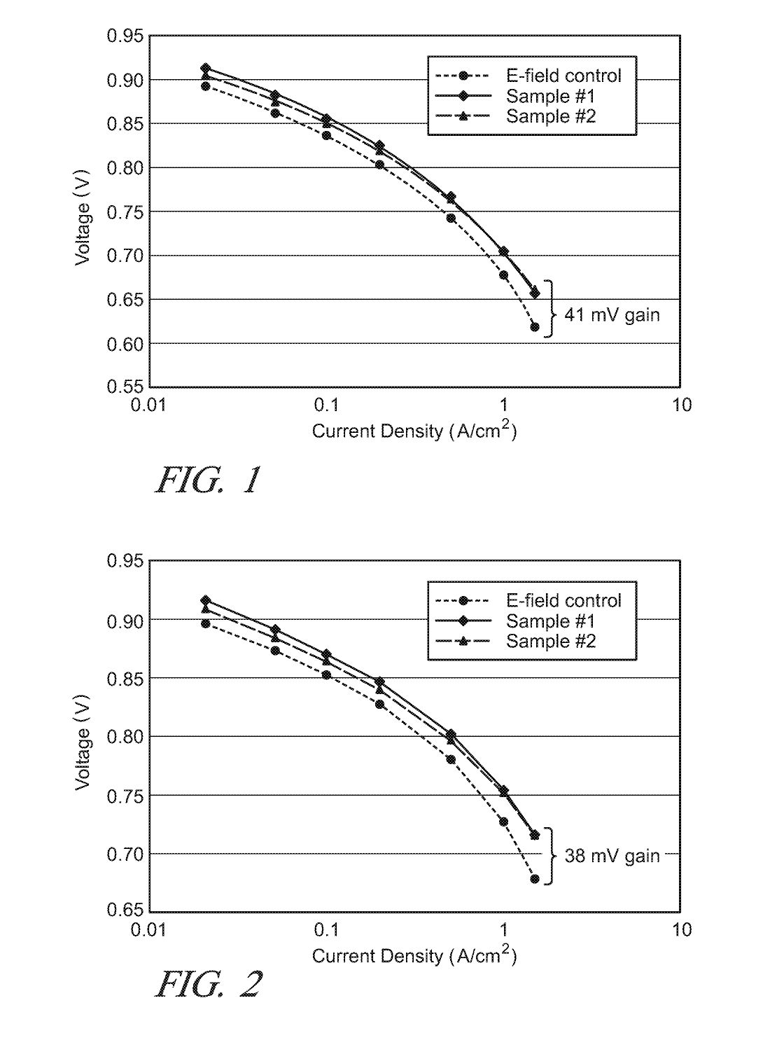

The polarization curves were taken from high current input to low current input with 15 min of waiting between each point, the last 5 of which were averaged and plotted to construct a polarization curve. As shown in FIGS. 1 and 2, the performance of the Sample #1 and #2 was also improved (about 40 mV higher than E-field control at 1.5 A/cm²) under both conditions (80° C., 70% and 100% RH).

The invention has been described in terms of specific examples which are illustrative and not limiting of the scope of the invention.

1. A method of making a proton exchange membrane where the membrane consists essentially of a polymer of a molecular morphology having ionic phase clusters dispersed in a non-ionic continuous phase; the method comprising:
placing the polymer in a state in which the ionic phase clusters can be aligned by an applied alternating electrical field;
shaping the polymer in the desired form of a membrane having opposing major surfaces separated by a thickness;
applying an alternating electric field to the polymer to align the ionic phase clusters in the direction of the thickness of the membrane; and
maintaining the applied field while removing the polymer from the state in which the ionic phase clusters are mobile to fix the ionic phase clusters in alignment with the thickness direction of the membrane.

2. A method of making a proton exchange membrane as recited in claim 1 in which the membrane is formed of a perfluorosulfonic acid having a non-ionic phase of perfluoroethylene molecular moieties and ionic phase clusters of perfluorinated ether side chains terminated with sulfonate groups.

3. A method of making a proton exchange membrane as recited in claim 1 in which the membrane is formed of a non-fluorinated sulfonated ionomer.

4. A method of making a proton exchange membrane as recited in claim 1 in which the membrane is formed of one ionomer selected from the group consisting of sulfonated polysulfone, sulfonated poly(ether ether ketone), sulfonated polyimide, sulfonated poly(phenylene oxide) and sulfonated polycarbonate.

5. A method of making a proton exchange membrane as recited in claim 1 in which the polymer is heated to a temperature in which the ionic phase clusters can be aligned by an applied electrical field

6. A method of making a proton exchange membrane as recited in claim 1 in which the polymer is dissolved in a solvent for alignment of the ionic phase clusters.

7. A method of making a proton exchange membrane where the membrane consists essentially of a polymer of a molecular morphology having ionic phase clusters dispersed in a non-ionic continuous phase; the method comprising;
dissolving the polymer in a solvent;
casting the dissolved polymer on a surface for the formation of a membrane having opposing major surfaces separated by a thickness;
applying an alternating electric field to the dissolved polymer to align the ionic phase clusters in the direction of the thickness of the membrane; and
maintaining the applied electric field while evaporating the solvent to leave the membrane in which the ionic phase clusters are fixed in alignment with the thickness direction of the membrane.

8. A method of making a proton exchange membrane as recited in claim 7 in which the membrane is formed of a perfluorosulfonic acid having a non-ionic phase of perfluoroethylene backbone molecular moieties and ionic phase clusters of perfluorinated ether side chains terminated with sulfonate groups.

9. A method of making a proton exchange membrane as recited in claim 7 in which the membrane is formed of a non-fluorinated sulfonated ionomer.

10. A method of making a proton exchange membrane as recited in claim 7 in which the membrane is formed of one ionomer selected from the group consisting of sulfonated polysulfone, sulfonated poly(ether ether ketone), sulfonated polyimide, sulfonated poly(phenylene oxide), and sulfonated polycarbonate.

11. A proton exchange membrane having opposing membrane surfaces separated by a generally uniform thickness, the membrane consisting essentially of a single polymer material of a molecular morphology having ionic phase clusters dispersed in a non-ionic continuous phase, the ionic phase clusters being aligned in the direction of the thickness of the membrane.

12. A proton exchange membrane as recited in claim 11 in which the membrane is formed of a perfluorosulfonic acid having a non-ionic phase of perfluoroethylene backbone molecular moieties and ionic phase clusters of perfluorinated ether side chains terminated with sulfonate groups.

13. A proton exchange membrane as recited in claim 11 in which the membrane is formed of a non-fluorinated sulfonated ionomer.

14. A proton exchange membrane as recited in claim 11 in which the membrane is formed of one ionomer selected from the group consisting of sulfonated polysulfone, sulfonated poly(ether ether ketone), sulfonated polyimide, sulfonated poly(phenylene oxide), and sulfonated polycarbonate.
